(19) United States
(12) Patent Application Publication
(10) Pub. No.: US 2010/0173101 A1
(43) Pub. Date: Jul. 8, 2010

(54) METHOD OF MANUFACTURING THICK-FILM, LOW MICROWAVE LOSS, SELF-BIASED BARIUM-HEXAFERRITE HAVING PERPENDICULAR MAGNETIC ANISOTROPY

(75) Inventors: Vincent G. Harris, Sharon, MA (US); Carmine Vittoria, Boston, MA (US); Frederic Joseph Rachford, Washington, DC (US); Yajie Chen, Brookline, MA (US)

Correspondence Address: WEINGARTEN, SCHURGIN, GAGNEBIN & LEBOVICI LLP, TEN POST OFFICE SQUARE, BOSTON, MA, 02109, US

(73) Assignees: Northeastern University, Boston, MA (US); The Governer of the United States, As Represented By The Secretary Of Yhe, Arlington, VA (US)

(21) Appl. No.: 12/377,181

(22) PCT Filed: Aug. 10, 2007
(86) PCT No.: PCT/US07/17786

§ 371 Date: Feb. 11, 2009

Related U.S. Application Data
(60) Provisional application No. 60/837,447, filed on Aug. 11, 2006.

(51) Int. Cl. B05D 3/14; B05D 5/12

(52) U.S. Cl. 427/598; 427/130

(57) ABSTRACT

A method of producing a relatively-thick film of a magnetic material on a substrate for use in microwave and millimeter wave devices is disclosed. The method includes preparing a wet paste comprising a binder material, glass frit, and a finely-grained magnetic material; applying the wet paste over a stencil, template or mask disposed on the substrate, to form a film on a surface of the substrate; drying the wet paste within an applied magnetic field, to vaporize fluid and organic compounds in the binder material and to produce a desired magnetic orientation in the magnetic film; and sintering the magnetic film. Hot pressing the magnetic film during sintering by adding weight on the film improves density.

### CROSS REFERENCE TO RELATED APPLICATIONS

Claim of priority of U.S. Provisional Patent Application No. 60/837,447 filed on Aug. 11, 2006, entitled PROCEDURE FOR PROCESSING LOW MICROWAVE LOSS, SELF-BIASED BARIUM-HEXAFERRITE THICK FILMS HAVING PERPENDICULAR MAGNETIC ANISOTROPY is asserted.

### STATEMENT REGARDING FEDERALLY SPONSORED RESEARCH OR DEVELOPMENT

This invention was funded all or in part by the Office of Naval Research (ONR) under the terms of ONR Contract Number N00014-05010349 and by the Defense Advanced Research Projects Agency (DARPA) tinder DARPA Contract Number HR0011-05-1-0011. The Federal government retains certain rights to this invention and enjoys a non-exclusive, royalty-free license to the invention.

### FIELD OF THE INVENTION

The present invention relates to the propagation of electromagnetic waves in microwave and millimeter wave devices such as planar microwave magnetic devices. More specifically, the present invention relates to the field of microwave magnetic devices and circulators and, more particularly, to a process for manufacturing a self-biasing, relatively-thick, relatively-low microwave loss, relatively-high remanent magnetic material for use with, inter alia, planar microwave circulators.

### BACKGROUND OF THE INVENTION

In applications ranging from wireless communication to radar, in certain microwave and millimeter wave devices, conventional wisdom relies on permanent magnets to provide an external magnetic biasing field to magnetically saturate the ferrite material in the sending, receiving, and manipulation of electromagnetic signals. Traditionally and problematically, however, permanent magnets are relatively large, which impacts efforts to reduce the size of the devices and adds expense to processing and assembly.

Omitting the bulky permanent magnets has been a long sought goal in the microwave community. However, in order to replace permanent magnets, the ferrite material must be dense, pure phase, and self-biasing, which is to say that the material must remain magnetized even after an applied magnetic field is removed. Other desirable properties for the ferrite material include high saturation magnetization, high remanent magnetization, low microwave losses, e.g., low ferromagnetic resonance linewidths, an ability to be made relatively thick, i.e., typically greater than about 300 microns.

One means of avoiding permanent magnets involves the use of magnetic hexagonal barium ferrite materials, such as, for example, M-type barium-hexaferrite (BaFe₁₂O₁₉), to propagate electromagnetic waves in microwave and millimeter wave devices. Barium-hexaferrite has a hexagonal crystal structure that has a relatively high effective internal field due to its inherent, strong crystalline anisotropy. As a result, barium-hexaferrite is self-biased, which is to say it remains magnetized even after a magnetic field is removed.

Barium-hexaferrite, also known as magnetoplumbite, has become a magnetic material of choice for microwave and millimeter wave applications that include, inter alia, filters, isolators, and, most importantly, circulators. Advantageously, barium-hexaferrite exhibits a strong uniaxial anisotropy. Consequently, the magnetic “easy” axis aligns along the crystallographic c-axis. As is well known to those skilled in the art, the magnetic “easy” axis determines the preferred orientation of magnetization. Hence, if one can align the barium-hexaferrite crystallites with their c-axes along one direction, then the sample will have a strong magnetic anisotropy favoring that direction. Consequently, the magnetization in microwave magnetic devices can be selectively aligned perpendicular to the plane of the device. This further maximizes the magnetic filling factor and effectively couples the electromagnetic wave.

Efforts to produce magnetic ferrite films on suitable substrates for microwave and millimeter wave devices have occurred in recent years. For example, pulsed laser deposition (PLD) has been used to produce high quality barium-hexaferrite films on various substrates. With PLD, a laser is used to ablate a molecular flux from a homogenous target. A substrate is interposed to intercept the flux. By maintaining the process at a high temperature, a film of the ablated target material is deposited and grown on the substrate. Disadvantageously, with PLD technology, film thickness is limited, growth rates are relatively slow, the surface area of substrates is relatively limited, and the film exhibits relatively low remanent magnetization, i.e., low or no self-biasing.

Liquid phase epitaxy (LPE) has been used to process high quality barium-hexaferrite and yttrium iron garnet (YIG) films having a thickness between about 100 microns and about 200 microns on some microwave substrates. By LPE, a single-crystal seed is placed into a molten solution containing barium-hexaferrite. As the seed is rotated, the temperature of the molten bath is reduced by which a barium-hexaferrite film is grown on the seed.

However, efforts to produce thicker films by LPE have resulted in unacceptable surficial cracking, making low loss device fabrication impossible. Furthermore, although LPE films exhibit low microwave loss, remanent magnetization is very small, precluding self bias operation.

Conventional bulk compacts prepared in a magnetic field demonstrate self-biasing properties at relatively large thicknesses, i.e. in millimeters. However, grain alignment in bulk materials depends in large part on utilization of a relatively-high strength magnetic field often generated by either permanent magnets or Helmholtz coils. Bulk compacts also require special dies and other manufacturing tools and additional process steps, to cut and polish the final product.

Accordingly, methods and the products of such methods for manufacturing relatively-thick (typically greater than 300 microns), self-biased, relatively-low microwave loss materials to replace permanent magnets in microwave and millimeter wave applications are needed. Indeed, there is no known, single process that enables fabrication of barium-hexaferrite films, which are characterized by thicknesses of up to about one (1) mm, perpendicular magnetic polarization, relatively-low microwave losses, and self-biased properties, over a large surface area in a cost effective manner.

### BRIEF SUMMARY OF THE INVENTION

The present invention provides a method of manufacturing a self-biasing magnetic material, such as barium-hexaferrite, that can be manufactured in thicknesses greater than about 300 microns over relatively large surface areas, e.g., areas greater than about 10 in.×10 in. The resultant magnetic material is characterized as having relatively-high remanent magnetization, e.g., as high as about 96% of saturation values; having perpendicular magnetic anisotropy, which is to say that magnetization is aligned perpendicular to the film plane; and having relatively low microwave losses, e.g., ferromagnetic resonance (FMR) linewidths no greater than about 350 Oe.

For example, a method of producing a relatively-thick film of a magnetic material on a substrate for use in microwave and millimeter wave devices is disclosed. The method includes preparing a wet paste comprising a binder material, glass frit, and a finely-grained magnetic material; applying the wet paste over a stencil, template or mask disposed on the surface of the substrate, to form a film thereon; drying the wet paste within an applied magnetic field, to vaporize fluid and most organic compounds in the binder material and to produce a desired magnetic orientation in the magnetic film; and sintering the magnetic film.

More specifically, the wet paste is dried and the binder vapors and most organic compounds are burned-out at a temperature between about 150 and about 250 degrees Centigrade (° C.) (about 300 and about 480 degrees Fahrenheit (° F.)) for between about one (1) and about 20 minutes in a magnetic field with an applied field strength between about 500 and about 10,000 Oe. The applied magnetic field is oriented to be aligned perpendicularly to or substantially perpendicularly to the plane of the magnetic film and has sufficient strength to cause an alignment of or to orient the magnetic material along the direction of the applied magnetic field, i.e., to cause the c-axes of magnetic material particles to align along the direction of the applied magnetic field, which is perpendicular to or substantially perpendicular to the plane of the film.

The magnetic film is sintered at a temperature between about 850° C. and about 1300° C. (about 1650° F. and about 2370° F.) for between about two and about ten hours. Those organic compounds that were not burned out during the first heat treatment are vaporized during the sintering process. Optionally, the magnetic film can be further sintered and annealed, e.g., at a temperature between about 600° C. and about 1300° C. (about 1110° F. and about 2370° F.) for between about one (1) and about 15 hours.

A method of producing a relatively-thick film of a magnetic material on a substrate so that c-axes of magnetic material particles in the magnetic material are aligned in a direction that is perpendicular to or substantially perpendicular to the plane of the film, using a screen printing process is also disclosed. The method includes applying a stencil, template or mask to the surface of the substrate; applying a wet paste comprising particles of magnetic material combined with a binder to the stencil, template or mask; applying a magnetic field having a predetermined field strength and a predetermined orientation to the wet paste and substrate; and drying the applied wet paste to produce a magnetic film.

Also disclosed are self-biasing magnetic films for microwave or millimeter wave devices and microwave or millimeter wave devices having a self-biasing magnetic film that are manufactured in accordance with the methods of the present invention.

### BRIEF DESCRIPTION OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views.

FIG. 1 shows a flow chart of a method of manufacturing a self-biasing, relatively-thick, relatively-low microwave loss, relatively-high remanent magnetic material in accordance with the present invention;

FIG. 2A shows a scanning electron microscopy (SEM) image of oriented screen-printed film after low temperature treatment;

FIG. 2B shows a SEM image of the oriented screen-printed film of FIG. 2A after an optimized, high temperature heat treatment;

FIG. 2C shows a SEM cross-section image of the oriented screen-printed film of FIG. 2B;

FIG. 3 shows x-ray diffraction patterns (θ-2θ using Cuk_{\acute{α}} radiation) displaying strong (0, 0, 2n) reflections consistent with barium-hexaferrite grains oriented with their c-axis perpendicular to the sample plane;

FIG. 4 shows magnetic hysteresis loops with applied field aligned in the sample plane (∘) and aligned perpendicular to the sample plane (▪);

FIG. 5 shows ferromagnetic resonance (FMR) linewidth spectra as derivative of power absorption versus frequency;

FIG. 6 shows a diagram of a screen-printing device in accordance with the present invention; and

FIG. 7 shows a diagram of a hot-press sintering process in accordance with the present invention.

### DETAILED DESCRIPTION

The present invention relates to the application of a magnetic film material that is characterized as relatively-thick (up to about 500 microns), having relatively-high remanent magnetization (greater than about 96 percent of saturation values), having oriented magnetic materials, and exhibiting relatively-low microwave loss, e.g., ferromagnetic resonance (FMR) linewidths of less than about 350 Oe.

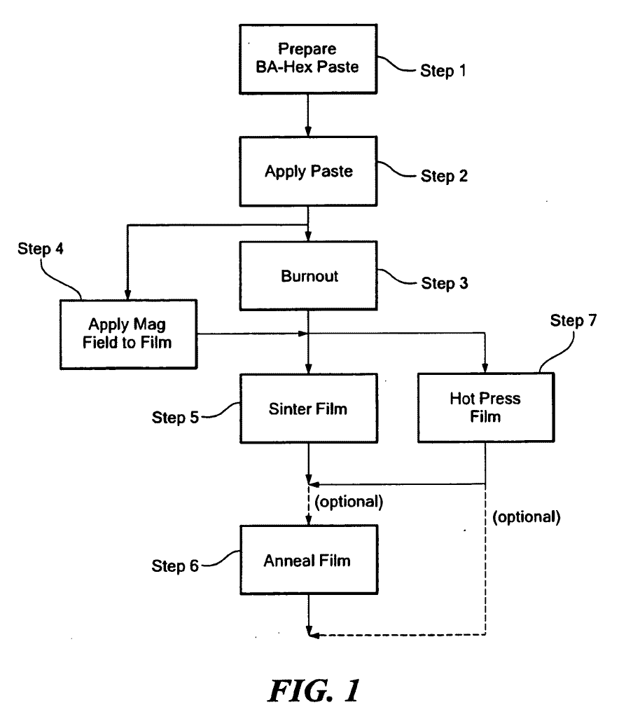

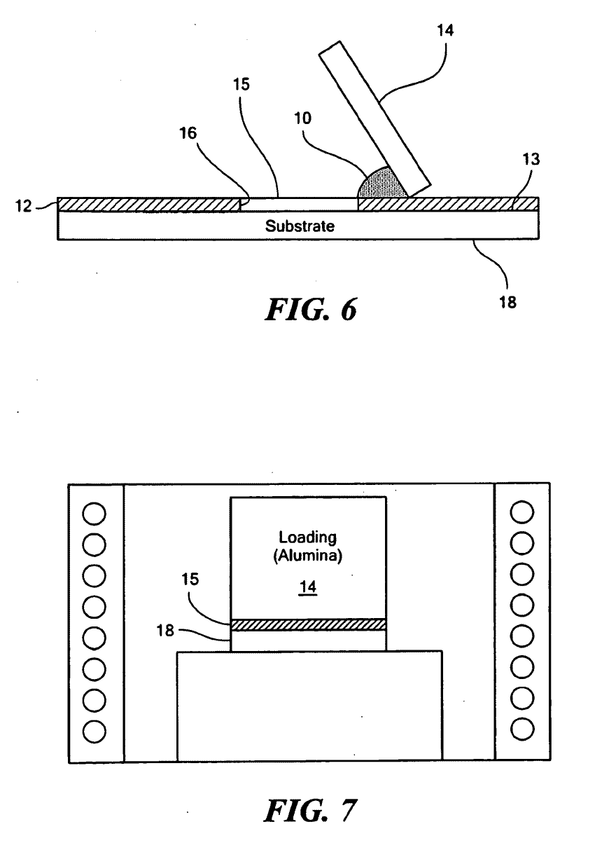

Referring to FIGS. 1, 6, and 7, a method of manufacturing a self-biasing magnetic film on a substrate for use in microwave and millimeter wave applications using screen printing technology is shown. The material for the self-biasing magnetic film can include, for example and without limitation, barium ferrite, c-axis-oriented barium ferrite, M-type barium ferrite, barium-hexaferrite, barium ferrite doped with at least one of scandium, indium, aluminum or gallium, and the like. For the remainder of this disclosure, it will be assumed that the magnetic material is barium-hexaferrite.

Sample preparation (STEP 1) includes preparing a wet paste comprising a magnetic material, such as barium-hexaferrite, for application to a surface of a suitable microwave or millimeter wave substrate. The barium-hexaferrite particles, or powder, can be prepared according to conventional ceramic processing techniques. Ball milling the powder can reduce the diameter of the powder particles to about one micrometer (μm). Alternative starting materials include magnetic materials processed through chemical processes.

The wet paste includes a binder, e.g., B-75000 manufactured by the Ferro Corporation of Cleveland, Ohio, in which particles of the magnetic material and glass frit, i.e., SiO₂, are suspended. An exemplary wet paste suitable for screen-printing consists of about 25.5 percent (by weight) binder, about 2.5 percent (by weight) glass frit, and about 72 percent (by weight) barium-hexaferrite. The binder provides a matrix for the magnetic materials. The glass frit enables the relatively-thick wet paste to adhere to the substrate better during the sintering process described below.

A stencil, template, screen, mask, and the like 12 having a desired, predetermined thickness and a desired, predetermined pattern of discrete openings 16 can be positioned on the surface 13 of the microwave substrate 18, e.g., a thin, alumina substrate. The paste 10 is then applied to, e.g., spread onto, the surface 13 of the suitable microwave substrate 18 (STEP 2), through the various openings 16 in the stencil, template, screen, mask, and the like 12. As with conventional screen-printing, a bladed instrument 14 can be used to spread the paste 10 across the stencil, template, mask, and the like 12 and into the openings 16. After the paste 10 is applied to the surface 13 of the substrate 18, the stencil, template, mask, and the like 12 can be removed.

The resulting wet, magnetic film 15 and substrate 18 are then heated in a first heat treatment (STEP 3) at a relatively-low temperature in a process called “burn-out”. The first heat treatment (STEP 3) is characterized as lasting between about one (1) and about 20 minutes at a temperature between about 150 and about 250 degrees Centigrade (° C.), or about 300 and about 480 degrees Fahrenheit (° F.). The relatively-low-temperature heat treatment (STEP 3) is designed to vaporize fluid and most organic compounds in the binder material, leaving a porous magnetic film 15 of barium-hexaferrite and frit on the surface 13 of the substrate 18. The range of temperatures for the first heat treatment (STEP 3) is high enough to vaporize fluid and most organic compounds in the binder but cannot “burn-out” the binder. The resulting magnetic film 15 contains a porous residual binder.

During the first heat treatment (STEP 3), the wet paste 10 is simultaneously subjected to a relatively-large strength magnetic field (STEP 4). Using, for example, an electromagnet, a magnetic field can be applied to the “wet” paste 10 (STEP 4) during the first heat treatment (STEP 3). The purpose of the applied magnetic field is to align the barium-hexaferrite particles with respect to the direction of the magnetic field, which is perpendicular to or substantially perpendicular to the film plane, and to self-bias the barium-hexaferrite particles. The strength of the applied magnetic field is between about 500 and about 10,000 Oe, which is sufficient to cause the alignment of, i.e., to orient, the barium-hexaferrite particles with respect to the direction of the magnetic field and, more particularly, to cause the c-axes of the hexaferrite particles, to align along the direction of the applied magnetic field, i.e., perpendicular to or substantially perpendicular to the film plane.

The magnetic film 15 then undergoes a second (STEP 5) and, optionally a third heat treatment (STEP 6). The second heat treatment (STEP 5) includes heating the magnetic film 15 and the substrate 18 in an ambient atmosphere to a temperature between about 900° C. and about 1300° C. (about 1650° F. and about 2370° F.) for about one (1) to about 15 hours, to sinter the film 15. During the sintering process, those organic compounds that were not burned out during the first heat treatment are vaporized. The sintering temperature is chosen based on the magnetic and microwave or millimeter wave properties desired in the resulting film 15 and on any desired loading during the sintering process, such as “hot pressing”.

After sintering, the film 15 has a dense, polycrystalline structure with grains oriented with the c-axis, perpendicular to or substantially perpendicular to the film plane. The degree and extent of recrystallization also depends on the sintering temperature and time.

The third heat treatment (STEP 6) is sometimes required to complete the sintering, to reduce strain, and/or to cause the annealing of the magnetic film 15. The optional third heat treatment (STEP 6) includes heating the magnetic film 15 and the substrate 18 to a temperature between about 600° C. and about 1300° C. (about 1110° F. and about 2370° F.) for about one (1) to about 15 hours.

“Hot-pressing” the film 15 (STEP 7) during the sintering and/or annealing heat treatments (STEPS 5 and 6), is desirable to improve film density and to reduce microwave losses. “Hot pressing” includes loading an oxide substrate 14, e.g. an alumina substrate, having a weight of about 50 to about 500 grams on top of the film 15, causing a progressive densification of the film 15 during sintering and/or annealing. After completion of the sintering and/or the annealing step (STEPS 5 and 6) performed in conjunction with “hot pressing” (STEP 7), film density is improved by about 85 to about 97 percent.

An exemplary magnetic film can be fabricated using the following process:

| | FIRST | SECOND | THIRD | HOT-PRESS |
|---|---|---|---|---|
| | HEAT | HEAT | HEAT | WEIGHT |
| TEMP (° C.) | 200 | 1200 | 1000 | 200 g |
| TIME (Hrs.) | 0.083 | 4 | 10 | |

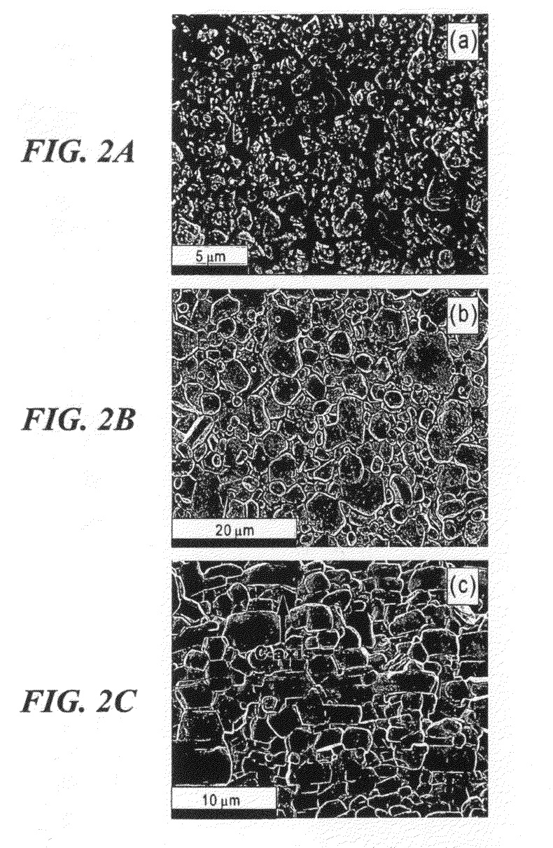

Using a Hitachi S-4800 ultrahigh resolution scanning electron microscope (SEM), an SEM image of screen-printed film after alignment and low-temperature heat treatment (STEP 3) is shown in FIG. 2A, and an SEM image of screen-printed film after sintering the film at about 1200° C. for about three hours (STEP 5) is shown in FIG. 2B. In FIG. 2A, the grains shown are loosely aligned, which may included some alignment, and the film appear to be relatively porous. In contrast, in FIG. 2B, the grains have grown in size, especially along the film plane, and the film appears to have a higher density, demonstrative of the appreciable and advantageous densification and grain growth that occurs as a result of the high-temperature sintering steps.

A SEM cross-section image of the film depicted in FIG. 2B is shown in FIG. 2C. In this image, the top of the image is closest the top of the film 15 and the bottom of the image is closest the substrate 18, large, columnar grains that are aligned perpendicular to the film plane are observable. In addition, isolated pores can be seen.

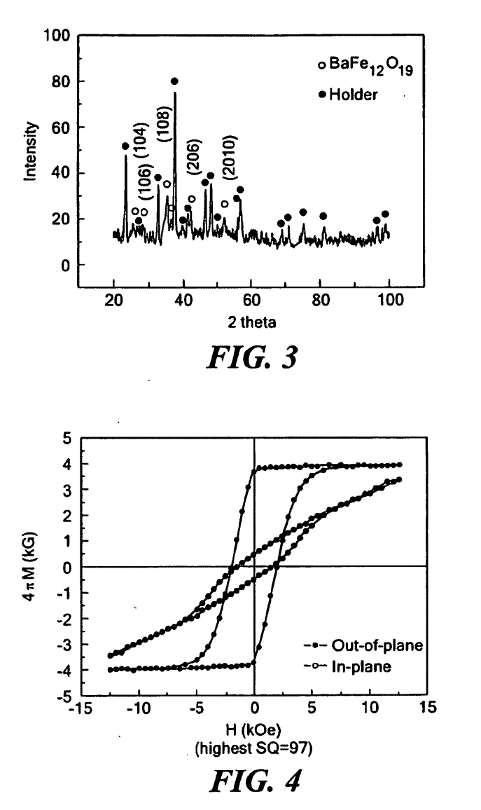

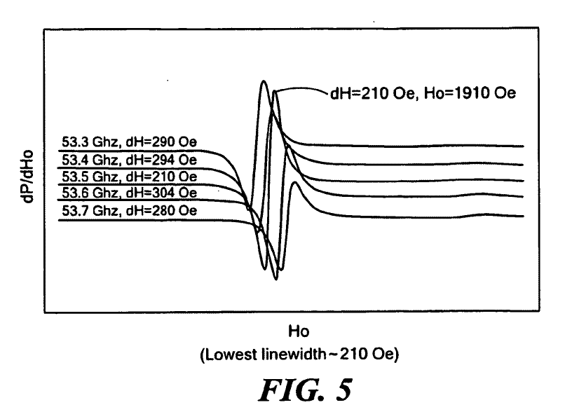

FIG. 3 is an x-ray diffraction pattern of the film 15 after alignment and optimized heat treatment. In the figure, the diffraction peaks indexed to (0, 0, 2n) have been identified to have enhanced intensities consistent with preferential alignment of c-axis grains perpendicular to the sample plane. The characterization of the film morphology and structure indicates a strong crystal texture of c-axis grains normal to the sample plane, which is essential to device operation. Resulting samples also exhibit a preferred direction of magnetization that is oriented perpendicular to or substantially perpendicular to the film plane and relatively-high remanent magnetization. More specifically, the sample remains magnetized perpendicular to the sample plane even after an externally applied magnetic saturation field is removed.

FIG. 4 is a plot of magnetic hysteresis loops made with the applied magnetic field aligned along the in-plane sample direction (∘) and perpendicular to the sample plane (▪). In FIG. 4, the square (▪) loop with high remanent magnetization corresponds to the out-of-plane orientation. Thus, it is shown that the magnetization prefers the direction normal to the sample plane, and also that, upon removal of the applied magnetic saturation field, the sample retains about 96 percent of the saturation magnetization. The other loop (o) corresponds to the magnetic hard axes parallel the sample plane.

Although the present invention has been described for application with circulators, the invention is not to be construed as being limited thereto. Indeed, further commercial applications can include isolators, filters, phase shifters, index lenses and index media, magnetic sensors, radiation-absorbing media, and the like.

The present invention has also been described assuming that the magnetic material is barium-hexaferrite. However, this was for convenience only and the invention is not to be construed as being limited thereto.

For growing relatively-thicker films over relatively-larger surface areas, multiple-pass, e.g., two or three layers, screen-printing is possible. Multiple-pass screen printing has been effective in reducing or eliminating cracking.

The foregoing description is not intended to be exhaustive or to limit the invention to the precise form disclosed. The embodiment was chosen and described to provide the illustration of principles of the invention and its application. Modification and variations are within the scope of invention.

I claim:

1. A method of producing a relatively-thick film of a magnetic material on a substrate for use in microwave and millimeter wave devices, the method comprising:
preparing an appliable wet paste comprising a first percentage (by weight) of a binder material, and a second percentage (by weight) of a finely-grained magnetic material;
applying the wet paste to form a film on a surface of the substrate, the substrate having a stencil, template or mask of a predetermined design and thickness on its surface;
drying the wet paste at a predetermined temperature for a predetermined amount of time within an applied magnetic field having a predetermined field strength and orientation, to produce a magnetic film; and
sintering the magnetic film at a predetermined temperature for a predetermined amount of time.

2. The method as recited in claim 1, wherein the magnetic material is a ferrite material selected from the group comprising barium ferrite, c-axis-oriented barium ferrite, M-type barium ferrite, barium-hexaferrite, or barium ferrite doped with at least one of scandium, indium, aluminum and gallium.

3. The method as recited in claim 1, wherein the wet paste is dried at a temperature between about 150 and about 250 degrees Centigrade (° C.) (about 300 and about 480 degrees Fahrenheit (° F.)) for between about one (1) and about 20 minutes and the applied magnetic field has a field strength between about 500 and about 10,000 Oe.

4. The method as recited in claim 3, wherein the applied magnetic field is oriented to be aligned perpendicularly to or substantially perpendicularly to the plane of the magnetic film.

5. The method as recited in claim 3, wherein the field strength of the applied magnetic field is selected to cause an alignment of or to orient the magnetic material along the direction of the applied magnetic field.

6. The method as recited in claim 5, wherein the strength of the applied magnetic field is selected to cause the c-axes of magnetic material particles to align along the direction of the applied magnetic field, which is perpendicular to or substantially perpendicular to the plane of the film.

7. The method as recited in claim 1, wherein the magnetic film is sintered at a temperature between about 850° C. and about 1300° C. (about 1650° F. and about 2370° F.) for between about two and about ten hours.

8. The method as recited in claim 1 further comprising:
annealing the magnetic film at a predetermined temperature for a predetermined amount of time.

9. The method as recited in claim 8, wherein the film is annealed at a temperature between about 600° C. and about 1300° C. (about 1110° F. and about 2370° F.) for between about one (1) and about 15 hours.

10. The method as recited in claim 8 further comprising:
hot-pressing the magnetic film simultaneously during the annealing process by applying a weight to the magnetic film.

11. The method as recited in claim 8, wherein the weight is about 50 to about 500 grams.

12. The method as recited in claim 1 further comprising:
hot-pressing the magnetic film simultaneously during the sintering process by applying a weight to the magnetic film.

13. The method as recited in claim 1, wherein applying the wet paste includes applying the wet paste using screen-printing techniques.

14. The method as recited in claim 1, wherein wet paste is prepare further comprising a third percentage (by weight) of glass frit.

15. A microwave or millimeter wave device having a self-biasing magnetic film that is fabricated on a substrate in accordance with the method of claim 1.

16. A self-biasing magnetic film for a microwave or millimeter wave device that is fabricated on a substrate in accordance with the method of claim 1.

17. A method of producing a relatively-thick film of a magnetic material on a substrate so that c-axes of magnetic material particles in the magnetic material are aligned in a direction that is perpendicular to or substantially perpendicular to the plane of the film, using a screen-printing process, the method comprising:
applying a stencil, template or mask having a predetermined design and thickness to a surface of the substrate;
applying a wet paste comprising particles of magnetic material combined with a binder to said stencil, template or mask and the surface of said substrate;
applying a magnetic field having a predetermined field strength and a predetermined orientation to the wet paste and to the substrate; and
drying the applied wet paste at a predetermined temperature for a predetermined amount of time while applying the magnetic field to produce a magnetic film.

18. The method as recited in claim 17, wherein the magnetic material is a ferrite material selected from the group comprising barium ferrite, c-axis-oriented barium ferrite, M-type barium ferrite, barium-hexaferrite, or barium ferrite doped with at least one of scandium, indium, aluminum and gallium.

19. The method as recited in claim 17, wherein the applied wet paste is dried at a temperature between about 150 and about 250 degrees Centigrade (° C.) (about 300 and about 480 degrees Fahrenheit (° F.)) for between about one (1) and about 20 minutes in a magnetic field with an applied field strength between about 500 and about 10,000 Oe.

20. The method as recited in claim 17, wherein the applied magnetic field is oriented to be aligned perpendicularly to or substantially perpendicularly to the plane of the magnetic film.

21. The method as recited in claim 17, wherein the field strength of the applied magnetic field is selected to cause an alignment of or to orient the magnetic material particles along the direction of the applied magnetic field.

22. The method as recited in claim 17, wherein the strength of the applied magnetic field is selected to cause the c-axes of magnetic material particles to align along the direction of the applied magnetic field, which is perpendicular to or substantially perpendicular to the plane of the film.
